(19) United States
(12) Patent Application Publication
(10) Pub. No.: US 2016/0048580 A1
(43) Pub. Date: Feb. 18, 2016

(54) METHOD AND SYSTEM FOR PROVIDING DELEGATED CLASSIFICATION AND LEARNING SERVICES

(71) Applicant: VERIZON PATENT AND LICENSING INC., Arlington, VA (US)

(72) Inventor: Madhusudan RAMAN, Sherborn, MA (US)

(21) Appl. No.: 14/459,985

(22) Filed: Aug. 14, 2014

(51) Int. Cl. G06F 17/30

(52) U.S. Cl. CPC G06F 17/30601; G06F 17/30876

(57) ABSTRACT

An approach is provided for delegated classification and learning services. The approach involves receiving a request for a deployment of a sensor classification service to an environment, wherein the environment includes one or more sensors. The approach also involves packaging one or more classification operations associated with the sensor classification service into a virtualization container, wherein the one or more classification operations are for processing sensor data collected from the one or more sensors. The approach further involves deploying the virtualization container to a node that is local to the environment to perform the one or more classification operations locally in the environment.

### BACKGROUND INFORMATION

Modern life is being transformed by the huge amount of data that is becoming available from all aspects of our everyday experiences. For example, inexpensive cameras, smartphones, or wearable devices and sensors have made it possible to continuously collect data across different modalities from our daily lives (e.g., what we see, what we hear or say, what we smell, where we go, etc. can be collected and stored). The challenge remains as how to process such data and infer useful information therefrom in the most reliable, inexpensive and time-efficient manner. Cloud computing based solutions have been proposed to address this challenge, wherein raw sensor data is transferred to a cloud of computers to take advantage of the computational and storage power of the cloud; however in most applications even such cloud-based solutions render ineffective, slow, or too expensive to be deployed as a service. For example, in the so-called smarthome technology/service a user may want to monitor his/her home via various sensors (e.g., light, odor, sound, video, etc.) and receive instantaneous or real-time alerts e.g., if the home smells of something bad or rotten or potentially dangerous/harmful. In this case constant monitoring of the home via numerous sensors yields huge amount of data every hour and sending such data to the cloud and processing therein is impractical and too expensive as is deploying a full-fledged powerful computer at home. A similar situation (with odor or other sensing modalities, attributes, qualities, and quantities) may happen in cases such as monitoring systems for factories, public places, infrastructures and roads, equipment, children or elderly care centers and hospitals, etc.

Therefore, the status quo is not desirable and as variety of sensors become available and continuously collect gigantic amounts of data there is a need for scalable, inexpensive, user-friendly, and energy-efficient approach to provide systems capable of real-time processing (e.g., filtering, feature extraction, classification, clustering, inference, estimation and prediction, etc.) of such data and provide services thereof.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIGS. 1A-C are diagrams depicting a system capable of providing delegated sensor data classification service according to various embodiments;

FIGS. 2A-C are flowcharts of the processes for providing delegated sensor data classification service, according to some embodiments;

FIG. 3 is a diagram of a system capable of providing delegated odor sensor data classification service, according to an exemplary embodiments;

FIG. 4 is a diagram of the process of provisioning the delegated sensor data classification service, according to an exemplary embodiment;

FIG. 5 is a diagram depicts an example of the process of olfactory data classification service, according to one embodiment;

FIG. 6 illustrates computing hardware (e.g., computer system) upon which an embodiment according to the invention can be implemented, according to an exemplary embodiment.

FIG. 7 is a diagram of a chip set that can be used to implement various exemplary embodiments.

### DESCRIPTION OF THE PREFERRED EMBODIMENT

A system, method, software, and apparatus for provisioning delegated sensor data classification and learning services are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

In what follows, for illustration purposes, examples are given where sensors deployed in an environment which might resemble a house or a residential environment and sensors may be odor sensors. However, it is obvious that methods and systems introduced herein can or may be employed in many other environments (public buildings, campuses, cars, etc.) and with other sensing modalities.

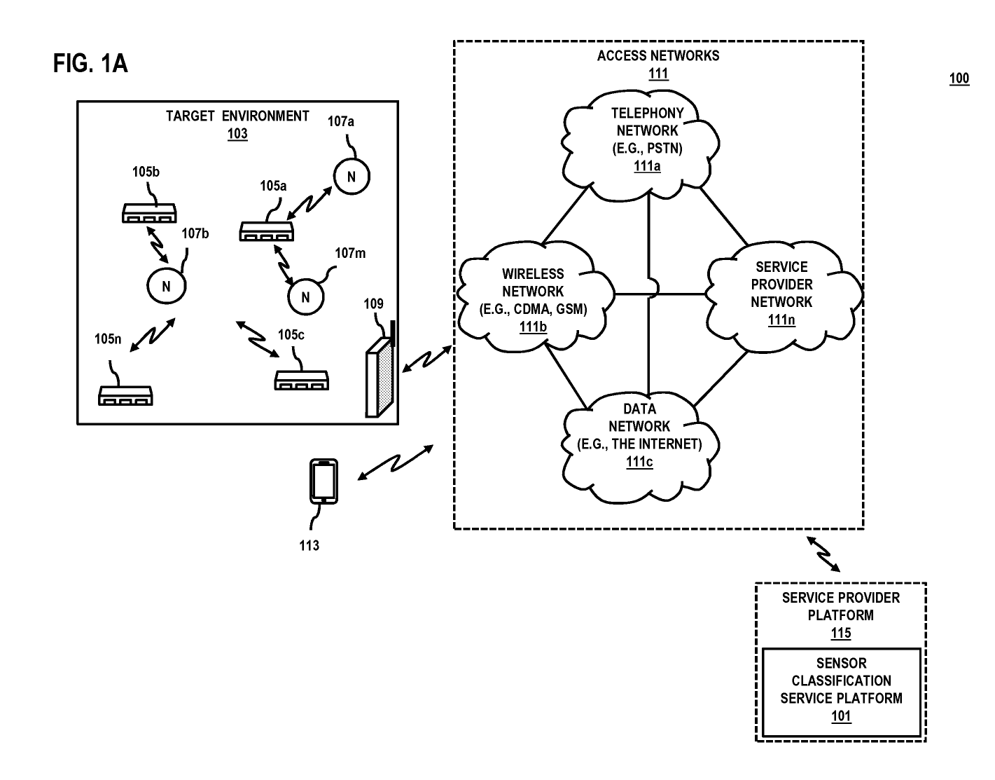

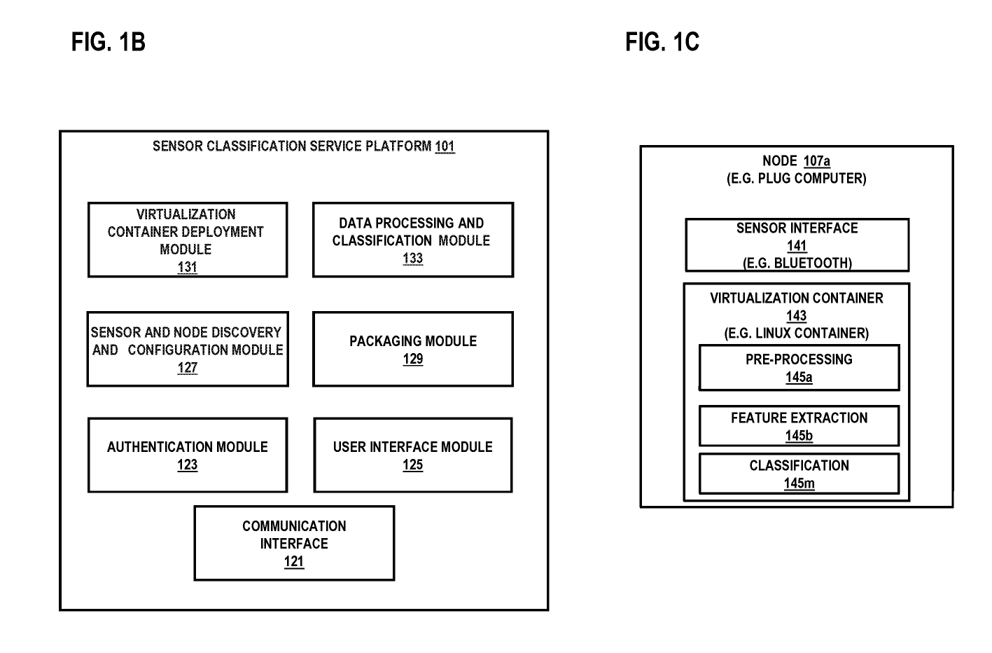

FIG. 1A illustrates a system 100 which is capable of providing scalable low cost and efficient sensor data classification and learning service. According to some embodiments, the sensor classification service platform 101 is introduced to provide classification of sensor data collected by sensors within or associated with a target environment 103. For example, the environment 103 may be a residential house, a public building, a large campus, a car, truck, or even an airplane, wherein sensors 105a-105n (collectively denoted as 105) are deployed to collected data in various modalities. As an example, the sensors 105 may be odor-sensitive sensors (e.g., Metal Oxide semiconductor Gas (MOG) and Quartz Crystal Microbalance (QCM) sensors sensitive to volatile organic molecules components of odors) and the platform 101 may provide service to classify various olfactory experiences within the environment (e.g., Green tea vs. English tea) in real-time. In other embodiments sensed data in other sensing modalities (e.g., sound, light, temperature, etc.) may be classified. In some embodiments, platform 101 may provide different classification results within various levels of location accuracy (e.g., rotten egg odor in a bedroom and English tea odor in the basement).

According to various embodiments nodes 107a-m (collectively denoted as 107) are deployed/dispersed within the target area 103. The nodes 107 may be computing or/and communication devices (such as small/lightweight plug computers) providing various levels of local computational power and connectivity (e.g., wired or wireless). More generally, a node 107a may be a consumer premise device (e.g., a set-top box). In some embodiments, a node 107a may be a user equipment such as a smartphone, tablet, etc., with certain level computational power. The nodes 107 may be configured to communicate with the one or more of the sensors 105 (in particular, receive the collected data therefrom). A node 107a may receive data from one sensor 105a or even more sensors. In certain embodiments short-range wireless technologies such as Bluetooth or infra-red connectivity may be employed to receive data with the sensors. In other embodiments, nodes 107 may be traditional computers, laptops, mobile devices, tablets, dedicated computing devices, or a combination thereof. In certain embodiments a node 107a and one or more sensor 105a may be packaged together.

Nodes 107 further may be capable to connect with the gateway 109, which in turn provides connectivity between the nodes 107 and the platform 101 through access networks 111a-n (collectively denoted as 111). According to certain embodiments, the gateway 109 may further be enabled to provide wireless (e.g., WiFi, optical, Bluetooth, etc.) or wired connectivity (e.g., Ethernet) to the nodes (or devices) 107. In some embodiment the gateway 109 may be a gateway providing access to/from a sensor network comprised of sensors 105.

For illustrative purposes, the access networks 111a-111n may be any suitable wireline and/or wireless network, and be managed by one or more service providers. For example, telephony network 111a may include a circuit-switched network, such as the public switched telephone network (PSTN), an integrated services digital network (ISDN), a private branch exchange (PBX), or other like network. Wireless network 111b may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (Wi-Fi), satellite, and the like. Meanwhile, data network 111c may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 111 may be completely or partially contained within one another, or may embody one or more of the aforementioned infrastructures. For instance, the service provider network 111n may embody circuit-switched and/or packet-switched networks that include facilities to provide for transport of circuit-switched and/or packet-based communications. It is further contemplated that networks 111 may include components and facilities to provide for signaling and/or bearer communications between the various components or facilities of system 100. In this manner, access networks 111 may embody or include portions of a signaling system 7 (SS7) network, or other suitable infrastructure to support control and signaling functions.

The access networks 111 may provide wired (e.g., copper, Fiber optics, co-axial cable, DSL, or a combination thereof) or wireless (e.g., cellular, satellite, WiFi, or a combination thereof) connectivity to/from a gateway 109 within or associated with a target environment 109. In some embodiments the gateway 109 may be a fiber optics access point or a fiber optics modem/and router providing wired or wireless access to various entireties associated with the target environment 103. In other embodiments the gateway may be a DSL or Cable mode/router. The access networks may also provide direct or indirect connectivity (i.e., without or without the need of gateway 109, respectively) to/from user equipment (UE) device 113. The UE 113 may be capable of accessing interfaces associated with the classification service and platform 101.

By way of example, the UE 113 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 113 can support any type of interface to the user (such as “wearable” circuitry, etc.).

In certain embodiments the nodes 107 may be able to communicate with each either directly or through the gateway 109 or through the platform 101. In some other embodiments nodes 107 may be accessed by and/or communicate with the UE 113 again either directly, through gateway 109 or platform 101, or other forms of connectivity.

In certain embodiments sensor classification service platform 101 may be implemented (wholly or partially) within a generic service provider platform 115 (possibly provided by a provider other than the provider of the sensor classification service). For example, the platform 101 may be implemented (partially or entirely) within a cloud computing platform/network in which a variety of connectivity (wired, wireless, cellular, etc.) and computation (e.g., hardware, software, distributed, parallel, cloud, clusters platforms) options may be provided.

FIG. 1B provides more details about the sensor classification service platform 101, according to some embodiments. The communication interface 121 may provide various levels of physical of virtual communication between the platform and different elements in FIG. 1A. In particular, depending on the access networks 111 and service provider platform 115, the interface 121 may be an application within any of the ISO network layers providing connectivity with the UE 113 and (through the gateway 109) with the nodes 107.

According to some embodiments, the authentication and user interface modules 123 and 125, facilitate secured and convenient access of a user to the platform 101 (or the services thereof), respectively. In particular, it is contemplated that a variety of security and authentication mechanisms can be employed to authenticate the user to have access to the service. A user interface may be provided by the user interface module 125 in a client-server manner, where the client can run as application on the UE 113. Through the user interface the user may provide settings or configurations or desired values for various parameters associated with the service including parameters associated with the environment 103, sensors 105, nodes 107, gateway 109, the classification experiences (e.g., type of odors to classify), or types of alters to be sent or types of triggers thereof, etc.

The sensor and node discovery and configuration module 127 may facilitate discovery and configuration of the sensors 105 and nodes 107. For example, the module 127 may facilitate configuring the sensors or nodes with the user-defined settings, or it can configure sensors to send data to a specific node or nodes.

The packaging module 129 and virtualization container deployment module 131 facilitate delegating efficient implementation of various pre-processing, feature extraction, and learning operations associated with the classification services to the nodes 107, thereby achieving real-time (or near-real-time) classification of sensor data in a collaborative manner. According to preferred embodiments, various operations associated with classification of data received from the sensors 105 may be packaged inside a virtualization container and be deployed for execution to the nodes 107. Given that in most scenarios the nodes 107 may be inexpensive computing nodes with limited computational, communication, and memory resources, the deployment or delegation of a virtualization container provides an efficient solution to bundle a set of programs, processes, operations to run on a node 107a. A virtualization container (e.g., a Linux container) as opposed to a virtual machine (VM), is an operating-system level virtualization instance which requires much less memory and computational resources, is more agile, allows enhanced sharing of resources on a node, and can be launched much faster.

Operations such as pre-processing and normalization of data, extracting most relevant features from the data, removal of noise, filtering of the data can be containerized (e.g., by the packaging module 129) and delegated to the nodes 107, according to certain embodiments. Therefore various embodiments provide efficient pre-processing and feature extraction of data locally, i.e., within nodes which are local to the environment 103 and close to the sensors 105, thereby eliminating the need for transferring data to the a central machine or VM, as in the current state-of-the-art.

It is contemplated that the feature extraction operation may include extracting more relevant feature for a specific classification purposes. Such a feature extraction may result in significant reduction in the data size or removal of redundant data, or keeping the most important/relevant part of the data for a specific purpose. Examples include linear or nonlinear dimension reduction (e.g., principal component analysis (PCA), multidimensional scaling (MDS), rank-based statistics, etc.). Other data normalizations such as nonlinear dynamic range reduction, standardizations (e.g., removing the mean, making the variance equal to a fixed number, etc.) may be part of pre-processing or normalization operations which could be containerized and delegated to the nodes 107. In particular, certain pre-processing operations may be performed in collaborative manner between the nodes (e.g., nearby nodes can collaborate to remove outliers from collected data).

In certain embodiments more operations such as classification operations e.g., neural networks, nearest neighborhood, support vector machine, Bayesian networks, Restricted Boltzmann Machines and other forms of deep learning networks, etc., or combination thereof may be packaged or containerized in a virtualization container and deployed by the virtualization container deployment module 131 to a node 107a.

According to some embodiments, the data processing and classification module can further perform more operation possibly on classification results obtained from nodes. For example, module 133 may include a meta-learning based classification algorithm such as Boot-strap AGGregatING (bagging), Boosting, backward feature elimination, or graph-based meta-learning based classification, or combination thereof to aggregate or improve classification results from individual nodes 107. Therefore, according to some embodiments nodes 107 (e.g., inexpensive plug computers) runs the lightweight, portable and self-sufficient containers, whereas the data processing and classification module is run on VM in a cloud. Hence the VM (with more computational power) may run bagging or boosting operations on the data received from containers across multiple plugs (nodes 107), providing near real-time sensing of the data collected by the sensor 105.

FIG. 1C schematically illustrates, by way of example, a node 107a upon deployment of a virtualization container, according to various embodiments. The node may include a sensor interface 141 e.g., Bluetooth circuitry and interfaces thereof (in hardware or software or a combination thereof) to provide receive data from the sensors 105 and provide or fed to a deployed or hosted virtualization container (or an instantiation or image thereof) 143. By way of example, the virtualization container 143 (a hence the node 107a) may be configured to perform operations such as pre-processing 145a, feature extraction 145b, or classification 145c or combination thereof, e.g., according to the above described approaches or other known ones. In some embodiments, the software part of the sensor interface 141 may as well be included in the virtualization container 143.

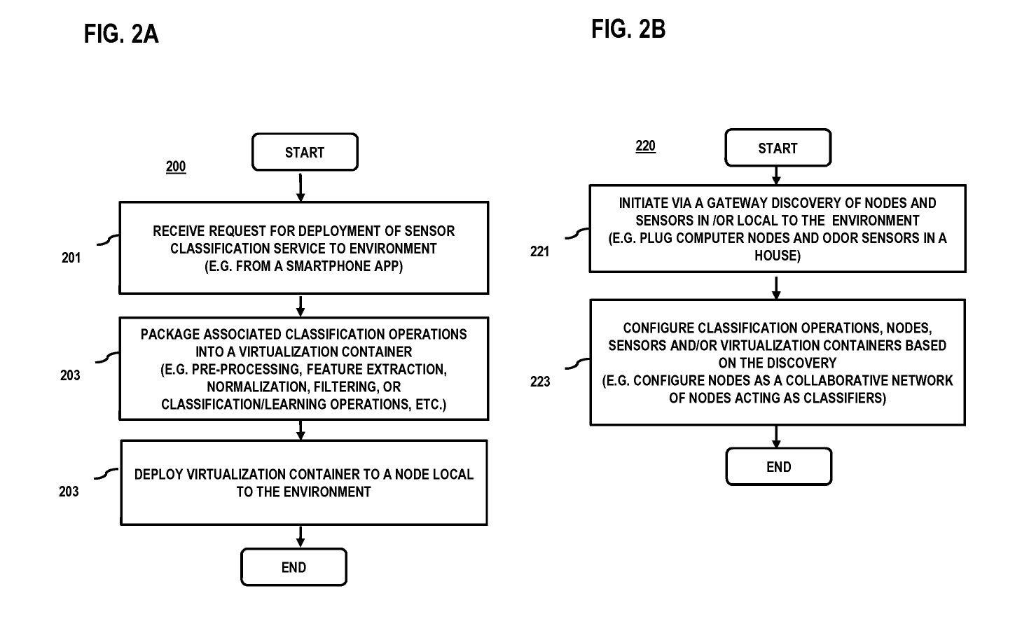

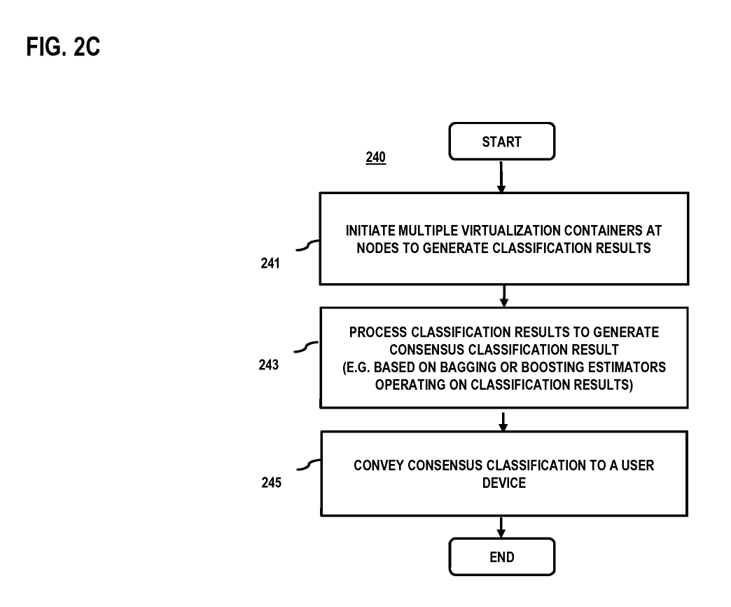

FIG. 2A is a flowchart of a process 200 for deployment of a virtualization container to a node 107, according to an embodiment. In step 201, a request for deployment of the sensor classification service is received e.g., through the user interface module 125 and application on the UE 113. The request may include various user-related, environment related, or other parameters. Based on the request in step 203, associated classification operations (e.g., pre-processing, filtering, feature extraction, classification and learning as described above) may be packaged (e.g., by packaging module 129) into one or more virtualization containers. In step 205, a virtualization container is deployed (e.g., by the deployment module 131) to a node 107 within or associated with the environment

FIG. 2B is a flowchart of a process 220 for discovery and configuring sensors 105 or nodes 107 within or associated with the environment 103, according some embodiments. In step 221 discoveries of one or more sensors or nodes is initiated via the gateway 109. This could result in discovering associated network addresses, physical locations, types of sensors and nodes (e.g., odor sensitive sensor and Linux plug computers, respectively), etc. Such information could be used in the classification related operations as well as in configuration of the sensors and nodes. In step 223, classification operations (or the virtualization container), nodes, and sensors are configured accordingly. As an example the nodes may be configured as a collaborative peer network of nodes (hence configured to communicate as described above) acting as local classifier and for that purpose virtualization container may be configured accordingly, and specific nodes and sensors may be paired. As another example, if a new node is added or discovered a new virtualization container may be packaged and deployed to the new node.

FIG. 2C is a flowchart of a process 240 for delegated sensor data classification according to various embodiments. In step 241, one or more virtualization containers (or instantiations thereof) are initiated at the nodes to generate classification results associated with data received from the sensor. In some embodiments nodes act alone and in some other they may act collaboratively. In step 243, (local) classification results from the nodes are further processed to generate a consensus classification result. In some embodiment this step may be, in part, performed by the data processing and classification module 133, which may perform a bagging or boosting operation based on the local classification results received from the nodes. In some other embodiments the module 133 may perform any other meta-learning based classification operation. In yet other embodiments certain nodes or all of them may perform bagging or boosting operations on their own and their neighbors classification results, or perform some form of consensus averaging algorithms to achieve consensus about sensor data received. In step 245, upon achieving consensus the consensus classification result may be conveyed to the UE 113.

In some embodiments the various classification operations performed (or the parameters thereof) may be trained before deployment or configuration of the service in a supervised manner and further be updated/improved in supervised/or unsupervised manner after deployment (during operation). In other embodiments the classification operations may be trained after deployment in a supervised or unsupervised manner (possibly with some supervision provided by users).

The above steps (and processes) were described with respect to the specific task of classification of data collected form sensors 105, according to some preferred embodiments. However, other embodiments may be directed, in an essentially similar approach, toward any other statistical inference operation on the data such as clustering, estimation, prediction, etc. In particular, associated virtualization containers may be configured, packaged, and deployed e.g., for clustering or discovery of various new olfactory experiences observed or to predict the level of a currently sensed odor in one hour, etc.

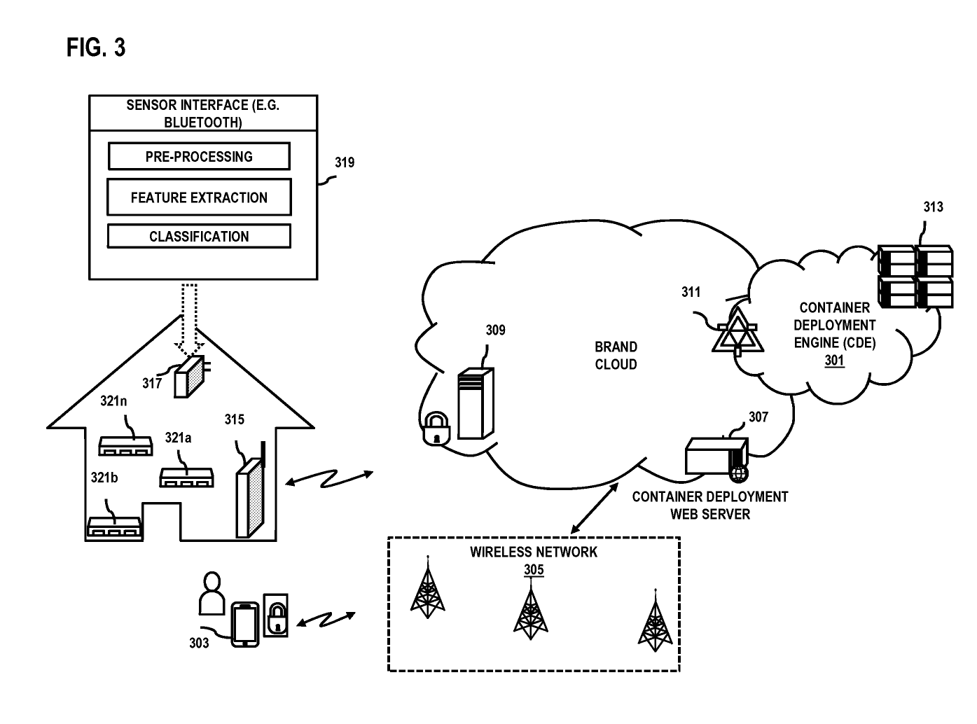

Next, with respect to FIG. 3 some preferred embodiments are described which relate to an odor sensing service in near-real-time. To demonstrate the benefits and use of the sensor classification methods described above an exemplary instance of the above delegation classification called Delegated Pre-processing and Feature extraction Classification (D-PFC) learning service is described with respect to olfactory experiences. It is obvious that odor classification is a time-sensitive and challenging task since if the classification is not done fast enough the smell would diffuse quickly and not sensible anymore.

According to preferred embodiments a novel aspect of the D-PFC Learning Service is to provide odor classification service using a low cost standalone node (e.g., a Linux plug computer) in a collaborative peer network of learners that is deployable as a cloud service. Another novel aspect, according to some embodiments, is that the D-PFC learning may include a meta-learning algorithm that extends and enhances a combination of traditional bagging, boosting and graph network techniques into the physical world. As yet another novel aspect, D-PFC learning service allows tuning the use of stand-alone and cloud network based convergence on actionable classification enabling local near-real-time response by the node. An exemplary embodiment directed toward odor sensing in near-real-time demonstrates the benefits and use of D-PFC learning deployment as a service at residential scale using cable, DSL, or fiber-optic gateway (e.g., a service provider gateway) or for remote sites using mobile or other wireless connectivity.

According to a preferred embodiment the odor classification service system depicted in FIG. 3 can be described as an enterprise cloud rebrandable white label service that provides economical classification of odors using the novel D-PFC learning technique deployable as “containers” on clustered low cost physical nodes. Today smartphone sensors are now available and cheap. However, the problem with such sensor is that they give gas components are not able to process the components into smells in real time. To do such processing one may need a larger device running a Virtual Machine (VM). Standard Virtual Machines (VMs) solve the problem of portability at the cost of additional hardware. For example the relevant application may require 1 GB of RAM while the VM may need 3 GB (extensive and expensive overhead).

The “container” approach disclosed herein, however, supports portability at a typical quarter of the cost of traditional VMs. This reduced footprint makes it suitable for the first time to deploy computation-intensive Pre-Processing, Feature Extraction and Classification (PFC) application on to a physical node such as a Linux plug computer. In FIG. 3, according to some preferred embodiments initial provisioning and software lifecycle updates may be handled by a Container Deployment Engine (CDE) 301. A consumer using a UE 303 may through an access network such as the wireless connection/network 305 (e.g., a cellular or WiFi access network) may connect to the Container Deployment Web Server 307 and authenticate him/herself via the authentication server 309. Consumer may be provided via the UE 303 access to the Container Deployment Interface (CDI) 311 which may guide the provisioning or updating of the service. The Container and Packaging Deployment Engine 313 may prepare the default containers (e.g., packages various operations such as pre-processing, feature extraction, classification, meta-learning based operations, sensor interfaces, etc. within a container appropriate to be deployed, see 319). The CDI 311 may further guide the interaction with the consumer's premise Wi-Fi network via the consumer premise router/gateway 315 discovering the physical node or nodes 317. A container image 319 may then be bootstrapped onto the nodes 317. Subsequent to the container coming online the sensors 321a-n may be auto-discovered and configured as part of the D-PFC network and the default meta-learning technique may be adopted to classify the odors, as described e.g., in FIG. 2A-C.

The examples given above were with respect to typical settings for residential consumers in terms of local connectivity and discovery. However, the described processes are equally applicable to any Wi-Fi equivalent network that is able to identify its edge nodes uniquely from a physical and virtual standpoint.

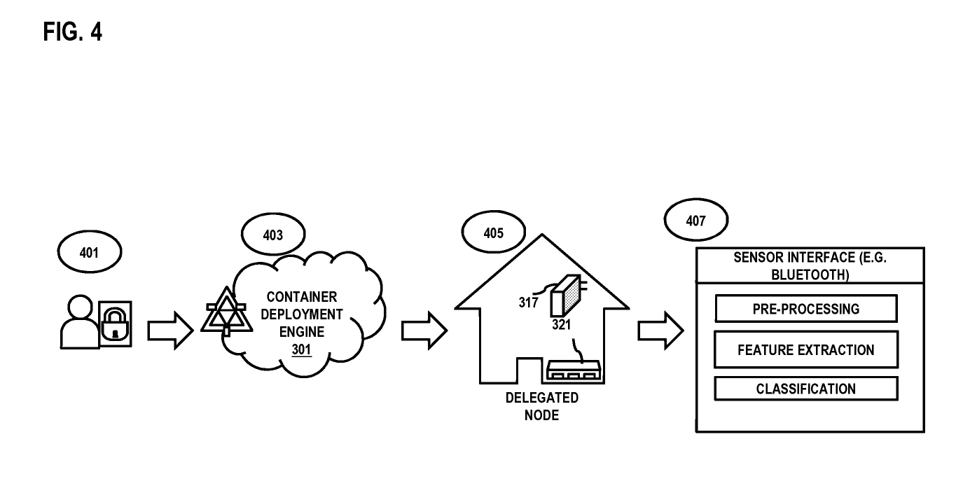

FIG. 4 illustrates, by way of example, the D-PFC based node provisioning and software update flow in some exemplary embodiments. In step 401 consumer may authenticate and request Odor classification service/update via the CDE 301 or a similar platform. In step 403, CDE 301 may configure a container for deployment to the consumer premise node(s) 317. In step 405, nodes 317 may be discovered via the consumer premise router or gateway (e.g., a service provider gateway 315) based network and then configured. In step 407, the delegated container may start up in default mode paired with accessible sensors.

In some embodiments, the CDE 301 may in turn be creatable on a VM and hence the setup shown is capable of supporting a managed cloud based service that can be hosted on the traditional VM architecture on a per instance basis for a Business-to-Business-to-Customer (B2B2C) specific offering.

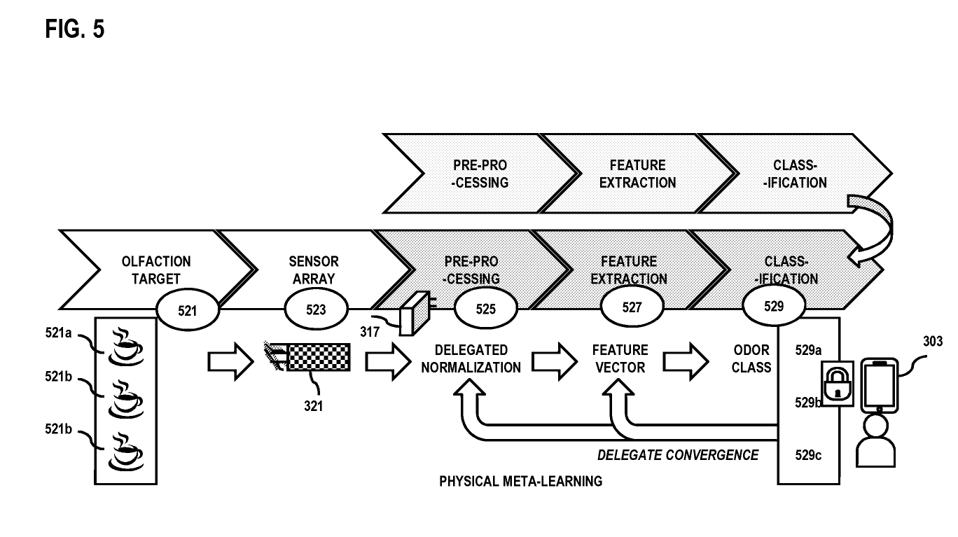

The deployment of the D-PFC service itself would be along the lines of the flow shown in FIG. 5. Container based deployment provides a four times advantage to traditional VM application deployment density in terms of memory and processing footprint making it possible for the first time to delegate computation intensive PFC on a Linux plug computer.

FIG. 5 depicts an odor classification use-case highlighting the functional contribution from each of the physical nodes 317 collaborating in a learner-predictor classification network (i.e., a physical meta-learning process). In step 521, an olfactory experience with different outcomes may happen, e.g., 521a, 521b, 521c in the example depicted could be English, Green or Oolong Tea for instance (obviously in other experiments there could be more than three types and various other smells such as farm smells may be included to have larger universe of odors). The target odor molecules are volatile organic molecules with relative molar masses between 30 and 300 Dalton covering a wide range of olfaction targets. In step 523, the odor pattern array may be obtained from Metal Oxide semiconductor Gas (MOG) and/or Quartz Crystal Microbalance (QCM) sensors 321.

The next three steps may include delegated operations, i.e., steps performed, at least in part, through a deployed container. In step 525, raw inputs may be transmitted to the participating nodes 317 to identify and remove noise and normalize multiple identifiers thereof. In step 527, feature vectors may be extracted emphasizing different identifiers in the node delegates.

In step 529, classification may be performed based on the bagged estimator with the lowest risk nodes that provide consensus (and corresponding classification results 529a-c may be conveyed to the UE 303). Also supported are boosting and backward feature elimination meta-learning based approaches. Specific classifiers may be one of the traditional ones including decision tree, neural net variations, fuzzy c-means, k-means clustering, nearest neighborhood classifiers, etc.

Various embodiments of this invention bring about the ability to run multiple application instances within one physical node. Thus the embodiments bring about the ability to have node collaborators which opens up the possibility for “physical” meta-learning operations. According to some embodiments, individual instances of learners may be used as part of an ensemble using physical outcome of bagged estimators that provide the lowest risk—i.e. output classification of odor is aligned with the consensus classification vote.

In some preferred embodiments a learning/predicting system (e.g., a container packed with relevant operations) may be deployed onto one or more of the nodes. Each such node may run bagging & boosting learning and classification. For example, in some embodiment a node may run learning systems on portions of the data and predict for the rest of the data. Hence a node may learn from the data from one sensor and predict on data from another sensor, and tune classification based on outcome accordingly. Thereby, in some embodiments, nodes (or a subset thereof) may run meta-learning locally as well and may perform bagging or boosting within one application. In some embodiments each node (e.g., a plug) may bag and boost across all nodes or plugs. In some embodiments an iterative process as depicted in FIG. 5 may be performed by which feedback learning (based on classification results or user's comments) is used tune the normalization and feature vector extraction steps until all the participating nodes converge to consensus vote. In some embodiments classification application may be run on the plugs and the outcome may be sent to the cloud.

It is noted that the odor classification example shown here is merely a representative of a class of real-time classification challenges that up to this time were not economically viable to solve in a fashion scalable to a residential market segment. Embodiments of this invention, in particular, the implementation of D-PFC learning in a container application allows for the novel use of delegate nodes as “physical” participants in a meta-learning implementation. It is contemplated that various embodiments may be employed in the Machine-to-Machine (M2M) industry. Today the gap is widening in this industry in terms of the raw input that is obtainable from sensors and the ability of networks to transport this data in real time to a facility capable of processing this enormous volume of data. Various embodiments of this invention, however, allow for the local (delegated) processing, feature extraction and classification computation reducing the need for transport for the bulk of the data. The D-PFC within a container node may act as a form of “Smart Filter” allowing the M2M industry to deal with high volume, velocity and variety of challenges emerging from the internet-of-things.

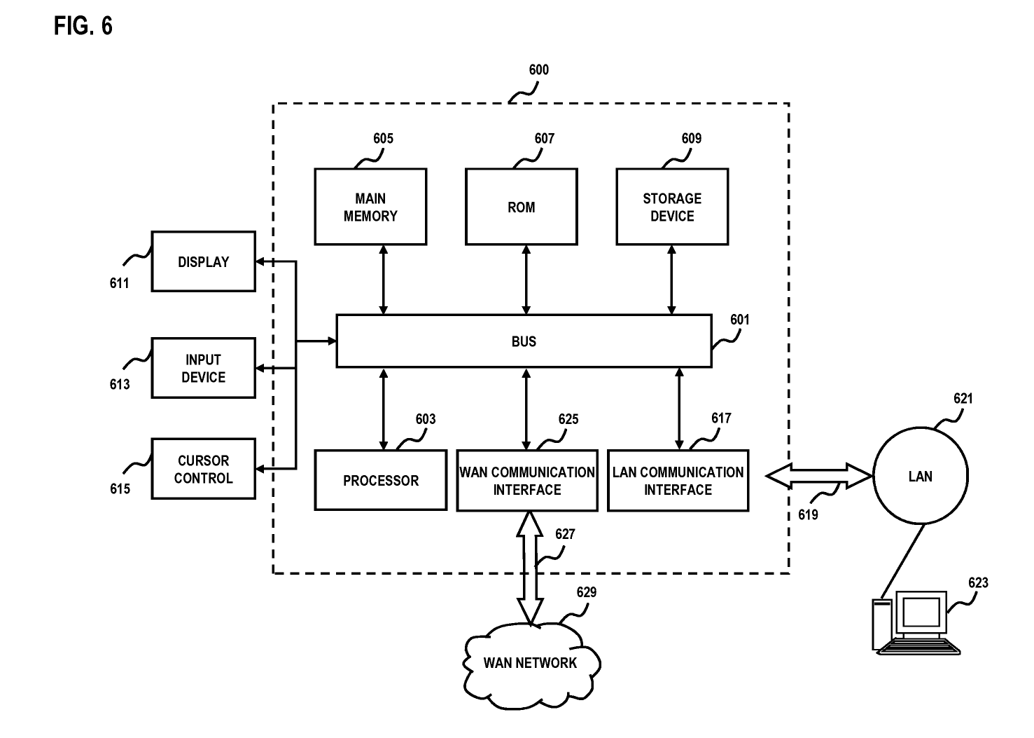

FIG. 6 illustrates computing hardware (e.g., computer system) upon which an embodiment according to the invention can be implemented. The computer system 600 includes a bus 601 or other communication mechanism for communicating information and a processor 603 coupled to the bus 601 for processing information. The computer system 600 also includes main memory 605, such as random access memory (RAM) or other dynamic storage device, coupled to the bus 601 for storing information and instructions to be executed by the processor 603. Main memory 605 also can be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to an embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. Thus, embodiments of the invention are not limited to any specific combination of hardware circuitry and software.

The computer system 600 also includes a communication interface 617 coupled to bus 601. The communication interface 617 provides a two-way data communication coupling to a network link 619 connected to a local network 621. As an example, communication interface 617 may be a local area network (LAN) card (e.g. for Ethernet™) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an embodiment of the invention through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

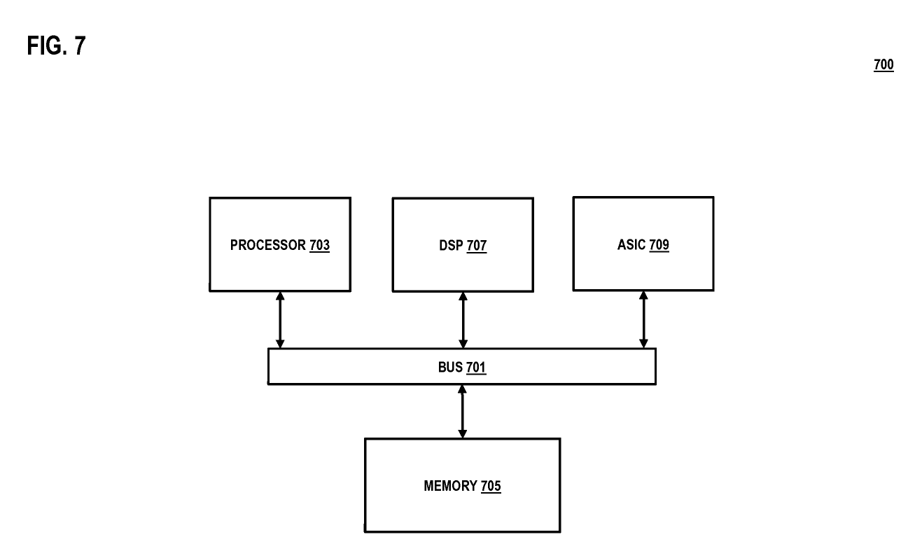

FIG. 7 illustrates a chip set 700 upon which an embodiment of the invention may be implemented. Chip set 700 is programmed to present a slideshow as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of FIGS. 2A-C or FIG. 5A.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to package and deploy virtualization container or perform subsequent classification related operations thereof. The memory 705 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving a request for a deployment of a sensor classification service to an environment, wherein the environment includes one or more sensors;
packaging one or more classification operations associated with the sensor classification service into a virtualization container, wherein the one or more classification operations are for processing sensor data collected from the one or more sensors; and
deploying the virtualization container to a node that is local to the environment to perform the one or more classification operations locally in the environment.

2. A method of claim 1, wherein the sensor classification service is an odor classification service to classify one or more olfactory experiences based on odor data collected by the one or more sensors.

3. A method of claim 1, further comprising:
initiating a discovery of the node, the one or more sensors, or a combination thereof in the environment; and
configuring the one or more classification operations, the virtualization container, or combination thereof based on the discovery.

4. A method of claim 3, further comprising:
performing the discovery via a network gateway to the environment.

5. A method of claim 1, further comprising:
initiating multiple instances of the virtualization container at the node to generate one or more sets of classification results; and
processing the one or more sets of classification results to generate a consensus classification result.

6. A method of claim 5, further comprising:
using a physical outcome of one or more bagged estimators operating on the one or more sets of classification results to generate the consensus classification result.

7. A method of claim 1, wherein the node is part of a collaborative peer network of one or more other nodes acting as one or more classifiers, one or more learners, or a combination thereof as part of the sensor data classification service.

8. A method of claim 1, wherein the one or more classification operations include a pre-processing operation, a feature extraction operation, a classification computation operation, or a combination thereof.

9. An apparatus comprising a processor configured to:
receive a request for a deployment of a sensor classification service to an environment, wherein the environment includes one or more sensors;
package one or more classification operations associated with the sensor classification service into a virtualization container, wherein the one or more classification operations are for processing sensor data collected from the one or more sensors; and
deploy the virtualization container to a node that is local to the environment to perform the one or more classification operations locally in the environment.

10. An apparatus of claim 9, wherein the sensor classification service is an odor classification service to classify one or more olfactory experiences based on odor data collected by the one or more sensors.

11. An apparatus of claim 9, wherein the processor is further configured to:
initiate a discovery of the node, the one or more sensors, or a combination thereof in the environment; and
configure the one or more classification operations, the virtualization container, or combination thereof based on the discovery.

12. An apparatus of claim 11, wherein the processor is further configured to:
perform the discovery via a network gateway to the environment.

13. An apparatus of claim 9, wherein the processor is further configured to:
initiate multiple instances of the virtualization container at the node to generate one or more sets of classification results; and
process the one or more sets of classification results to generate a consensus classification result.

14. An apparatus of claim 13, wherein the processor is further configured to:
use a physical outcome of one or more bagged estimators operating on the one or more sets of classification results to generate the consensus classification result.

15. An apparatus of claim 9, wherein the node is part of a collaborative peer network of one or more other nodes acting as one or more classifiers, one or more learners, or a combination thereof as part of the sensor data classification service.

16. An apparatus of claim 9, wherein the one or more classification operations include a pre-processing operation, a feature extraction operation, a classification computation operation, or a combination thereof.

17. A system comprising:
one or more sensors configured within an environment;
a node that is local to the environment; and
a platform configured to receive a request for a deployment of a sensor classification service to the environment; to package one or more classification operations associated with the sensor classification service into a virtualization container, wherein the one or more classification operations are for processing sensor data collected from the one or more sensors; and to deploy the virtualization container to the node to perform the one or more classification operations locally in the environment.

18. A system of claim 17, wherein the sensor classification service is an odor classification service to classify one or more olfactory experiences based on odor data collected by the one or more sensors.

19. A system of claim 17, wherein the platform is further configured to:
initiate a discovery of the node, the one or more sensors, or a combination thereof in the environment; and
configure the one or more classification operations, the virtualization container, or combination thereof based on the discovery.

20. A system of claim 17, wherein the platform is further configure to:
initiate multiple instances of the virtualization container at the node to generate one or more sets of classification results; and
process the one or more sets of classification results to generate a consensus classification result.
